(19) United States
(12) Patent Application Publication
(10) Pub. No.: US 2026/0195079 A1
(43) Pub. Date: Jul. 9, 2026

(54) IMAGE FORMING APPARATUS, CONTROL METHOD FOR IMAGE FORMING APPARATUS, AND STORAGE MEDIUM

(71) Applicant: CANON KABUSHIKI KAISHA, Tokyo (JP)

(72) Inventor: SHINICHI KANEMATSU, Chiba (JP)

(21) Appl. No.: 19/430,532

(22) Filed: Dec. 23, 2025

(30) Foreign Application Priority Data
Jan. 6, 2025 (JP) 2025-001911

(51) Int. Cl. G06F 3/12

(52) U.S. Cl. CPC G06F 3/121; G06F 3/1204; G06F 3/1229; G06F 3/1285

(57) ABSTRACT

An image forming apparatus comprising: a first unit; a second unit; one or more memories that store a set of instructions; and one or more processors that execute the set of instructions to: perform a first setting as to whether or not to transmit a first notification prompting replacement of the first unit to an external apparatus via a network on condition that a consumption level of the first unit has reached a predetermined consumption level; perform a second setting as to whether or not to transmit a second notification prompting replacement of the second unit to the external apparatus via the network on condition that a consumption level of the second unit has reached a predetermined consumption level; and control to transmit the first notification to the external apparatus based on the first setting and to transmit the second notification to the external apparatus based on the second setting.

### BACKGROUND

### Field of the Technology

The present disclosure relates to an image forming apparatus, a control method for the image forming apparatus, and a storage medium.

### Description of the Related Art

An image forming apparatus includes not only a consumable material that fixes an image onto a sheet, such as ink or toner, but also a component (hereinafter, also referred to as a consumable part) that is consumed in response to an image forming operation, such as an electro-photosensitive drum or a fixing unit. In such an image forming apparatus, in order to avoid deterioration or abnormality in a printed image from occurring due to consumption of parts, a replacement guideline is set by a manufacturer of the apparatus, for example. In a case where a consumable part that has reached a replacement guideline is detected, it is widely performed to display a message prompting replacement of the corresponding part onto an operation unit or the like of the image forming apparatus. Furthermore, it is also performed to notify an external apparatus of a replacement message and a consumption level of a consumable part via a network, and to use this notification in the external apparatus (see Japanese Patent Laid-Open No. 2003-186652).

It is conceivable that the replacement guideline of a consumable part is strictly set in order to avoid an abnormality in an image to be formed. However, it is conceivable that some users also have a need for using up a consumable part after understanding the influence on the image or the image quality by using the consumable part in excess of the replacement guideline. Such a user finds the notification for prompting replacement of the consumable part transmitted to the external apparatus via the network cumbersome. Therefore, it is conceivable to set ON/OFF of notification in the external apparatus. However, it is assumed that such notification setting is performed for each external apparatus. Therefore, such a notification setting is also found cumbersome to the user.

### SUMMARY

The present disclosure enables realization of a technique of reducing cumbersomeness that a user who uses an external apparatus communicating with an image forming apparatus via a network finds in a case of desiring to use a unit of the image forming apparatus in excess of a replacement guideline.

One aspect of the present disclosure provides an image forming apparatus comprising: a first unit; a second unit; one or more memories that store a set of instructions; and one or more processors that execute the set of instructions to: perform a first setting as to whether or not to transmit a first notification prompting replacement of the first unit to an external apparatus via a network on condition that a consumption level of the first unit has reached a predetermined consumption level; perform a second setting as to whether or not to transmit a second notification prompting replacement of the second unit to the external apparatus via the network on condition that a consumption level of the second unit has reached a predetermined consumption level; and control to transmit the first notification to the external apparatus based on the first setting and to transmit the second notification to the external apparatus based on the second setting.

Features of the present disclosure will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a block diagram of an image forming apparatus according to one embodiment.

FIG. 2 is an internal structure diagram of a print unit according to the embodiment.

FIG. 3 is a schematic diagram of an image forming system according to the embodiment.

FIGS. 4A and 4B are views illustrating a display screen of an external apparatus according to the embodiment.

FIG. 5 is a view illustrating a display screen of the image forming apparatus according to the embodiment.

FIG. 6A is a flowchart of processing according to the embodiment.

FIG. 6B is a flowchart of the processing according to the embodiment.

FIGS. 7A and 7B are views illustrating printer information according to the embodiment.

FIGS. 8A and 8B are views illustrating the display screen of the image forming apparatus according to the embodiment.

FIG. 9 is a view illustrating the display screen of the image forming apparatus according to the embodiment.

FIG. 10 is a view illustrating the display screen of the image forming apparatus according to the embodiment.

FIG. 11 is a view illustrating the display screen of the image forming apparatus according to the embodiment.

FIG. 12 is a view illustrating the printer information according to the embodiment.

FIG. 13 is a view illustrating table information on consumable parts according to the embodiment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

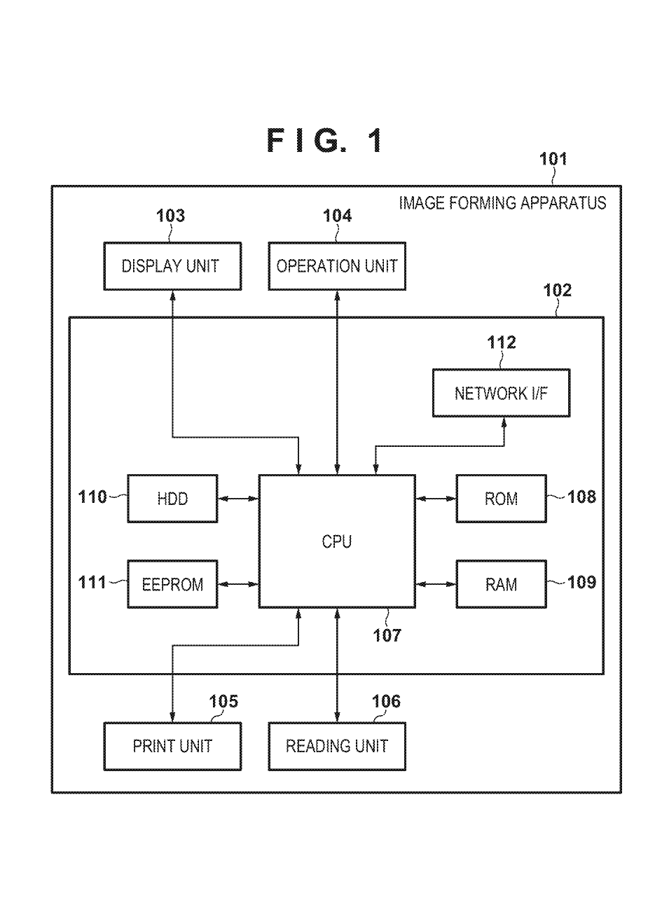

An outline of a configuration of an image forming apparatus 101 will be described with reference to FIG. 1. The image forming apparatus 101 includes a control unit 102, a display 103, an operation unit 104, a print unit 105, and a reading unit 106. The display 103 includes, for example, an LED and a liquid crystal display, and displays user operation content and internal information on the apparatus. The operation unit 104 includes a plurality of operation buttons and the like operable by the user. Alternatively, the operation unit 104 may include a touch panel display. Then, the operation unit 104 may include the function of the display 103. Note that in the following description, the operation unit 104 thus includes the touch panel display. The print unit 105 receives a print instruction from the control unit 102 and prints image data transmitted from the control unit 102 onto paper. The reading unit 106 receives a reading instruction from the control unit 102 to perform a sheet reading operation and transmits read image data to the control unit 102.

The control unit 102 includes a CPU 107, a ROM 108, a RAM 109, an HDD 110, an EEPROM 111, and a network I/F 112. The CPU 107 is an execution entity of a control program to be incorporated in the image forming apparatus 101, and controls the operation of an apparatus to be connected to the control unit 102 via each I/F, a memory of a storage medium, or the like. The ROM 108 is a read-only memory, and stores a boot program and the like necessary for system boot. The RAM 109 is a volatile memory, and is a work memory when the CPU 107 executes a control program. The HDD 110 is a storage medium such as a magnetic disk, and stores a control program, image data, and the like. The EEPROM 111 is a nonvolatile memory, and stores a setting value and the like when the control program is executed. The EEPROM 111 also stores information on a replacement guideline value and a consumption level for each consumable part described later. The network I/F 112 includes a communication module, and is connected to a network line 300. FIG. 3 illustrates a state in which the image forming apparatus 101 is connected to external apparatuses (301 and 302) via the network line 300. As illustrated in FIG. 3, the image forming apparatus 101 can communicate with the plurality of external apparatuses (301 and 302) and the like via the network, and can transmit and receive information regarding the consumable part described later. Note that in the example illustrated in FIG. 3, the number of external apparatuses is two, but the number of external apparatuses may be one or three or more.

The external apparatuses (301 and 302) are each a computer including, for example, a processor such as a CPU, a main storage apparatus such as a ROM and a RAM, and an auxiliary storage apparatus such as a hard disk drive. The external apparatuses (301 and 302) each further include a communication module such as a network interface card (NIC) and a wireless circuit, and a display apparatus such as a monitor. The auxiliary storage apparatus stores an operating system (OS), various programs, information in various table formats, and the like. Then, a stored program is loaded into a work area of the main storage apparatus and executed, and each component or the like is controlled through execution of the program, whereby each function matching a predetermined purpose as described later is implemented.

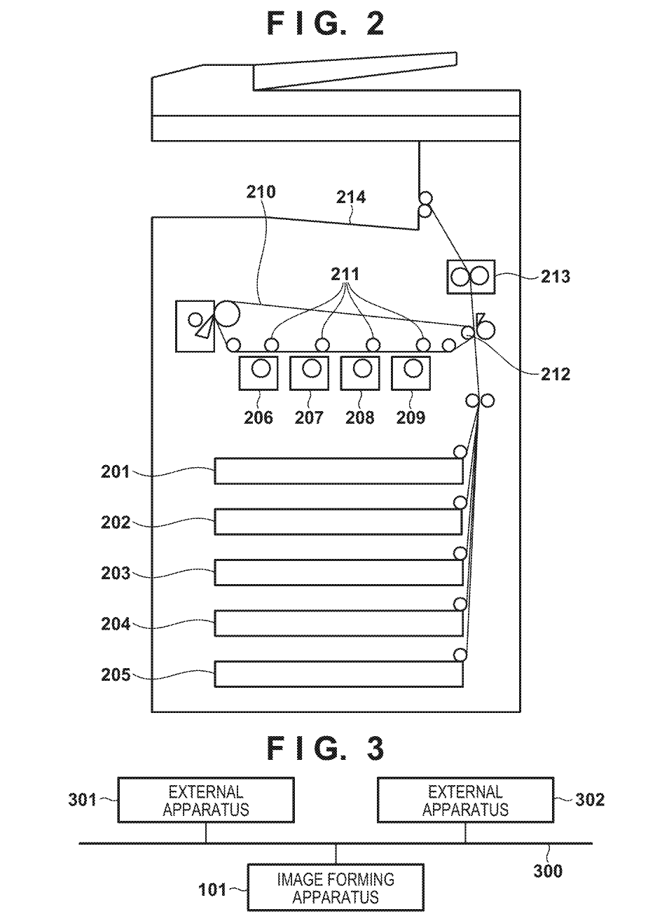

Next, a flow from when paper is fed from a paper feed unit in the print unit 105 to when the paper is discharged to a paper discharge unit after print will be described with reference to FIG. 2. The print unit 105 includes paper feed units 201 to 205, drum units 206 to 209, an intermediate transfer belt 210, a primary transfer roller 211, a secondary transfer roller 212, a fixing unit 213, and a paper discharge unit 214. Paper to be used for printing is set in the paper feed units 201 to 205. The paper to be set in each of the paper feed units may have a paper size and a paper type that can be printed by the print unit 105. In the present embodiment, the print unit 105 has a form of incorporating five paper feed units, but the form of the print unit 105 is not limited to this configuration.

The drum units 206 to 209 include electro-photosensitive drums corresponding to yellow (Y), magenta (M), cyan (C), and black (K), respectively. In the drum units 206 to 209, the electro-photosensitive drum is irradiated with a laser beam in accordance with the image data transmitted from the control unit 102, and then toner adheres, whereby development is executed. Then, after development, the drum units 206 to 209 transfer the toners of the respective colors to the intermediate transfer belt 210 by the primary transfer roller 211. Thereafter, the toner transferred to the intermediate transfer belt 210 is transferred by the secondary transfer roller 212 to the paper fed from any of the paper feed units 201 to 205. Then, the toner is fixed to the paper by heat and pressure by the fixing unit 213 after this transfer. Then, the paper on which the toner is fixed is discharged to the paper discharge unit 214. Thus, a printed matter corresponding to the image data transmitted from the control unit 102 is obtained.

The consumable part in the image forming apparatus 101 is, for example, the drum units 206 to 209 and the fixing unit 213 (an example of "unit" and "part that is consumed in response to image forming operation"). The CPU 107 counts the number of times of print of each consumable part every time image formation is performed, and writes and records an operation result into the EEPROM 111. A data table showing a relationship between the operation result and the replacement guideline value of consumable parts will be described with reference to FIG. 13. Note that such information is stored in the EEPROM 111. In the data table, a column 1301 indicates a replacement guideline (sheets), a column 1302 indicates an operation result (sheets), a column 1303 indicates a remaining amount (sheets) until the replacement guideline, and a column 1304 indicates a consumption level (%) with respect to the replacement guideline. Note that the count unit of the operation result of each part is the number of times of image formation for A4 size paper. The data table illustrated in FIG. 13 indicates a state in which the drum unit (Y) 206 corresponding to yellow (Y) among the consumable parts exceeds the replacement guideline. That is, it is a state in which, for example, the replacement guideline value of the drum unit (Y) 206 is 150000, and the operation result is 153230.

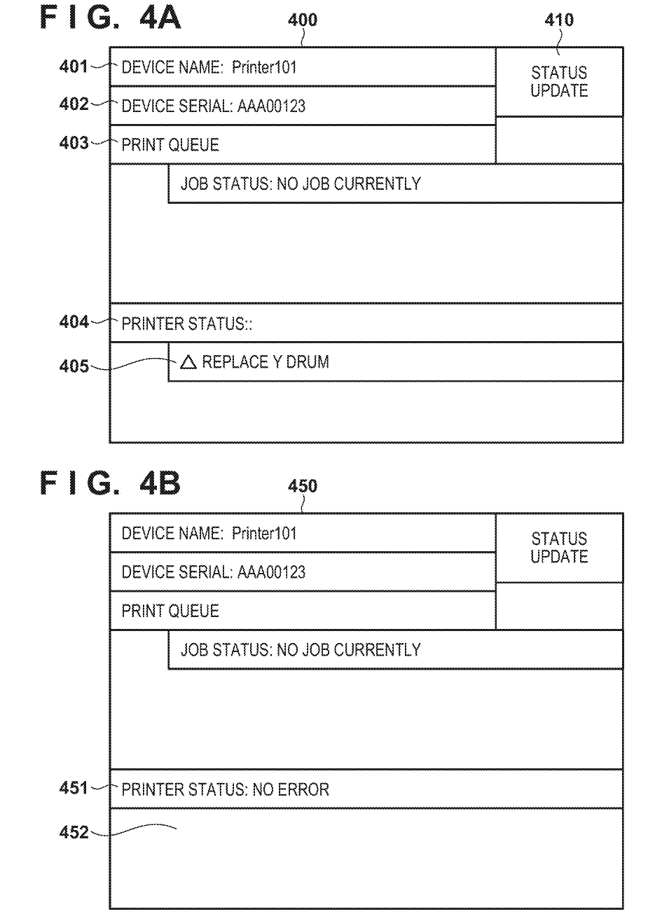

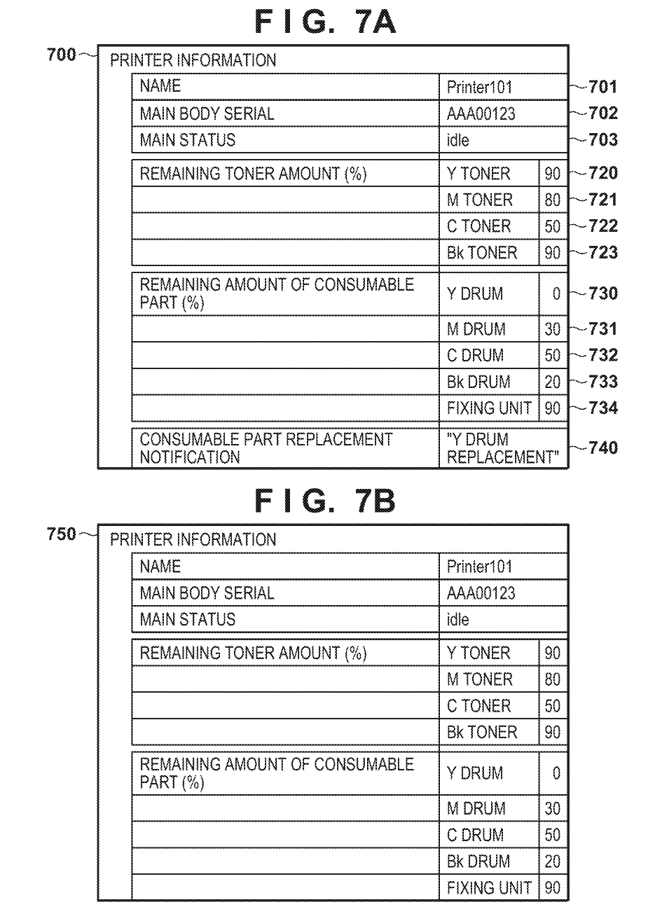

A display screen of the external apparatus 301 of the plurality of external apparatuses (301 and 302) will be described with reference to FIGS. 4A and 7A. The CPU of the external apparatus 301 is connected to the image forming apparatus 101 in a state where the consumables are as illustrated in FIG. 13 via a network using a communication module and acquires various statuses of the image forming apparatus 101 to display such a display screen onto the display apparatus.

More specifically, the CPU of the external apparatus 301 requests the image forming apparatus 101 to acquire an apparatus status. Then, printer information 700 illustrated in FIG. 7A is returned from the image forming apparatus 101. The printer information 700 includes, for example, a device name 701, a device serial number 702, and a main status 703 of the image forming apparatus 101. The printer information 700 includes remaining amounts (720, 721, 722, 723) of respective toners of Y/M/C/K, remaining amounts (730, 731, 732, 733) of respective drums of Y/M/C/K, which are consumable parts, a remaining amount 734 of the fixing unit, and a replacement notification 740 of the consumable parts. Note that these remaining amounts are remaining amounts displayed as percentages with respect to the replacement guideline.

The CPU of the external apparatus 301 having acquired the printer information 700 as illustrated in FIG. 7A displays the status of the image forming apparatus 101 onto a notification screen 400 as in FIG. 4A. The status includes a device name 401, a device serial number 402, a print queue unit 403 that lists jobs being executed, a printer information display 404, and a replacement message 405 corresponding to the replacement notification 740 of a consumable part. Note that the printer information display 404 illustrated in FIG. 4A indicates that no job exists in the image forming apparatus 101. The content of the replacement message 405 is, for example, "Replace Y drum", which is content allowing the user to recognize that the Y drum of the image forming apparatus 101 has reached the replacement guideline. The notification screen 400 includes a status update button 410 that can select update of the status. In this manner, a notification for prompting the user to replace a consumable part is displayed.

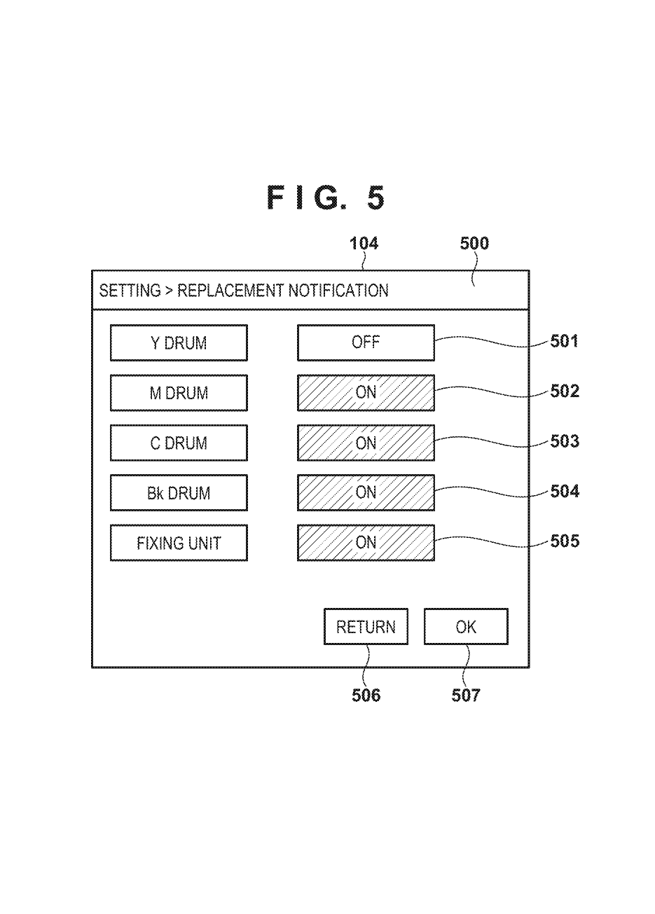

A setting screen 500 for replacement notification of consumable parts will be described with reference to FIG. 5. As illustrated in FIG. 5, the CPU 107 (an example of "display control unit") of the image forming apparatus 101 displays, on the operation unit 104, the setting screen 500 that can switch whether or not to notify of the external apparatus 301 of replacement of a consumable part. That is, the setting screen 500 displays switches (SW) 501 to 504 that can switch ON/OFF of the notification of replacement of the respective drums of Y, M, C, and K, and a SW 505 that can switch ON/OFF of the notification of replacement of the fixing unit 213. Such SWs 501 to 505 are provided for respective consumable parts (an example of "first object"). FIG. 5 illustrates a state in which the SW 501 corresponding to the Y drum is OFF and the other SWs 502 to 505 are selected ON. The setting screen 500 includes a button 506 for ending the setting screen 500 to return to a basic screen, and an OK button 507 for reflecting the state of the setting screen 500 in the setting.

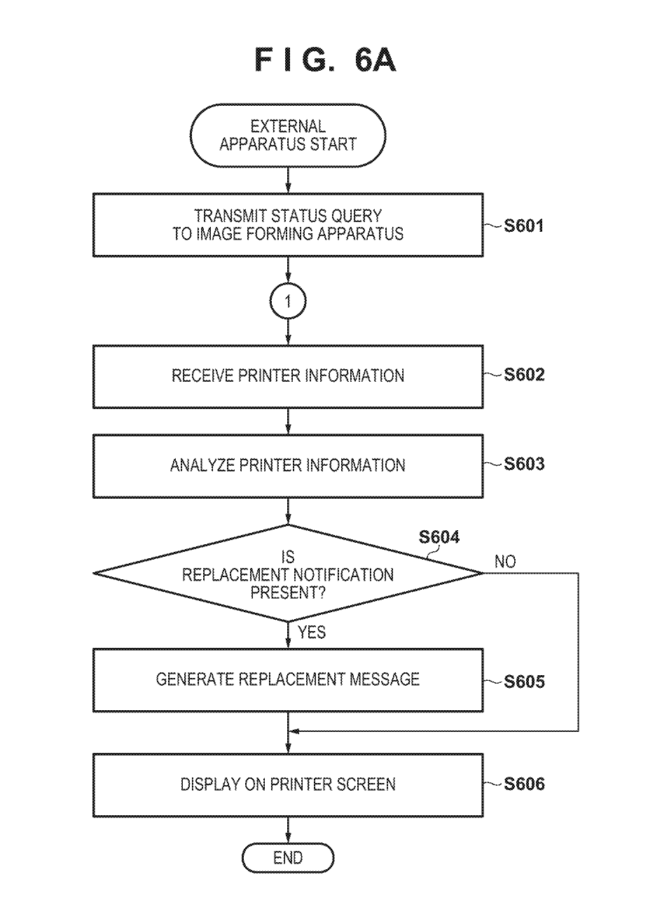

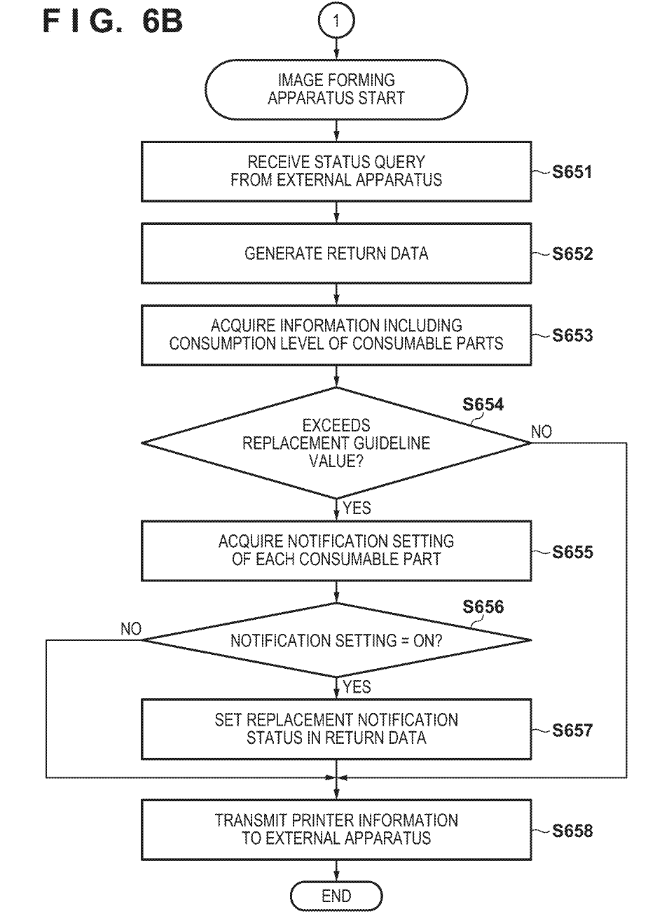

Sequence processing of the replacement notification of a consumable part from the image forming apparatus 101 to the external apparatus 301 will be described with reference to FIGS. 6A and 6B. The processing in FIG. 6A is implemented by the CPU of the external apparatus 301 reading a display application program stored in a storage medium such as a ROM into a RAM to execute it. The processing in FIG. 6B is implemented by the CPU 107 of the image forming apparatus 101 reading a program stored in the ROM 108 into the RAM 109 to execute it.

In S601 in FIG. 6A, the CPU of the external apparatus 301 transmits a request for printer state information to the image forming apparatus 101 using the communication module. The request issuance timing of the printer information from this external apparatus 301 is, for example, when the status update button 410 on the notification screen 400 of the external apparatus 301 illustrated in FIG. 4A is pressed. Alternatively, the request may be issued, for example, at the time when the external apparatus 301 is powered on, at the time when a print job is input to the image forming apparatus 101, or at regular time intervals. Then, the CPU of the external apparatus 301 waits for a response from the image forming apparatus 101.

A flowchart in the image forming apparatus 101 will be described with reference to FIG. 6B. In S651, the CPU 107 of the image forming apparatus 101 receives a request for printer information using the network I/F 112. In S652, the CPU 107 generates return data for returning the printer information to the external apparatus 301. Information on the device name, device serial number, job being executed, main status, and Y/M/C/K toners of the image forming apparatus 101 are collected and these pieces of information are used for generation of the return data. In S653, the CPU 107 reads the data table of consumables illustrated in FIG. 13 from the EEPROM 111.

In S654, the CPU 107 (an example of "determination unit") determines existence or absence of a consumable part exceeding the replacement guideline (an example of "predetermined value"). "Exceeding the replacement guideline" indicates that the consumption level illustrated in FIG. 13, for example, exceeds 100%. If the CPU 107 determines that there is a consumable part exceeding the replacement guideline, the processing proceeds to S655. In S655, the CPU 107 acquires setting information as to whether or not to notify of replacement of the consumable part exceeding the replacement guideline. Note that such setting information is information in which, when the CPU 107 detects a touch operation on the OK button 507 on the setting screen 500 illustrated in FIG. 5, selection information on the SWs 501 to 505 on the setting screen 500 is received and stored in a storage medium such as the RAM 109. In the data table illustrated in FIG. 13, the drum unit (Y) 206 exceeds the replacement guideline value. Therefore, the CPU 107 acquires selection information "OFF" of the SW 501 from the storage medium.

In S656, the CPU 107 determines as to whether or not the notification setting of the consumable part exceeding the replacement guideline is ON. Then, if the CPU 107 determines that the notification setting is ON, the processing proceeds to S657. In S657, the CPU 107 (an example of "setting unit") notifies the external apparatus 301 of replacement of the consumable part. Then, the CPU 107 adds, to the return data, a message indicating the replacement notification of the consumable part. This message is, for example, "Y drum replacement" as illustrated in FIG. 7A. In S658, the CPU 107 transmits, as printer information, the return data to which the message is added to the external apparatus 301 using the network I/F 112 (an example of "transmission unit"). Then, the processing in the image forming apparatus 101 ends.

On the other hand, if the CPU 107 determines in S656 that the notification setting is not ON, the processing proceeds to S658 without passing through S657, and then the processing ends. That is, in a case where the consumable part is in a state of the data table illustrated in FIG. 13, a message indicating replacement notification is not included in the printer information as illustrated in FIG. 7B. If the CPU 107 determines in S654 that there is a consumable part exceeding the replacement guideline, the processing proceeds to S658 without passing through S655 to S657, and then the processing ends. Also in such a case, a message indicating replacement notification is not included in the printer information.

The description returns to the flowchart of FIG. 6A. In S602, the CPU of the external apparatus 301 receives the printer information using the communication module. In S603, the CPU reads the content of the printer information to perform analysis. Then, the CPU generates a corresponding screen. In S604, the CPU determines as to whether or not a message indicating replacement notification is included in the printer information. Then, if the CPU determines that the message indicating replacement notification is included, the processing proceeds to S605. In S605, the CPU creates the replacement message 405 using the message indicating replacement notification. The CPU creates the notification screen 400 (FIG. 4A) including this replacement message 405, the device name 401, the device serial number 402, the print queue unit 403 that lists jobs being executed, and the printer information display 404. Then, in S606, the CPU displays the notification screen 400. Then, the processing in the external apparatus 301 ends.

On the other hand, if the CPU determines in S604 that the message indicating replacement notification is not included, the processing proceeds to S606 without passing through S605. In such a case, the CPU creates and displays a notification screen 450 not including the replacement message 405 (FIG. 4B). Then, the processing ends. Note that when the user desires to display the replacement message on the external apparatus 301, the user may perform a change operation on the SW 501 to ON on the setting screen 500 of the image forming apparatus 101. In a case where the change is made in this manner, the determination in S656 of FIG. 6B is YES, and a message indicating the replacement notification illustrated in FIG. 7A is set in the printer information in S657. Then, in S658, this printer information is returned to the external apparatus 301. In such a case, the determination in S604 is YES in the external apparatus 301, the replacement message 405 is created in S605, and the notification screen 400 (FIG. 4A) including the replacement message 405 is displayed. Note that the switching of the replacement notification described above is similarly applied to the drum units (207, 208, 209) corresponding to M/C/K other than the drum unit (Y) 206 and the fixing unit 213.

### One Aspect of Actions and Effects

According to the image forming apparatus 101 as described above, the drum unit (Y) 206 exceeds the replacement guideline, but the external apparatus 301 is not notified of the replacement notification 740 of the drum unit (Y) 206. Therefore, the replacement message 405 of the drum unit (Y) 206 is not displayed in the image forming apparatus 101. Therefore, it is less cumbersome to the user who desires to use the drum unit (Y) 206 in excess of the replacement guideline.

### FIRST MODIFICATION

The first modification shows an example of switching notification also for the replacement notification message for the consumable part displayed on the operation unit 104 of the image forming apparatus 101. This switching is implemented by the CPU 107 of the image forming apparatus 101 executing firmware that performs screen control of the operation unit 104. Switching whether or not to display the replacement message on the operation unit 104 may be linked to selection of the SW of the replacement message to the external apparatuses (301 and 302) on the network. Alternatively, separately from this SW, an SW may be newly provided, and this switching may also be linked to selection of the newly provided SW. Hereinafter, an example of providing another SW will be described.

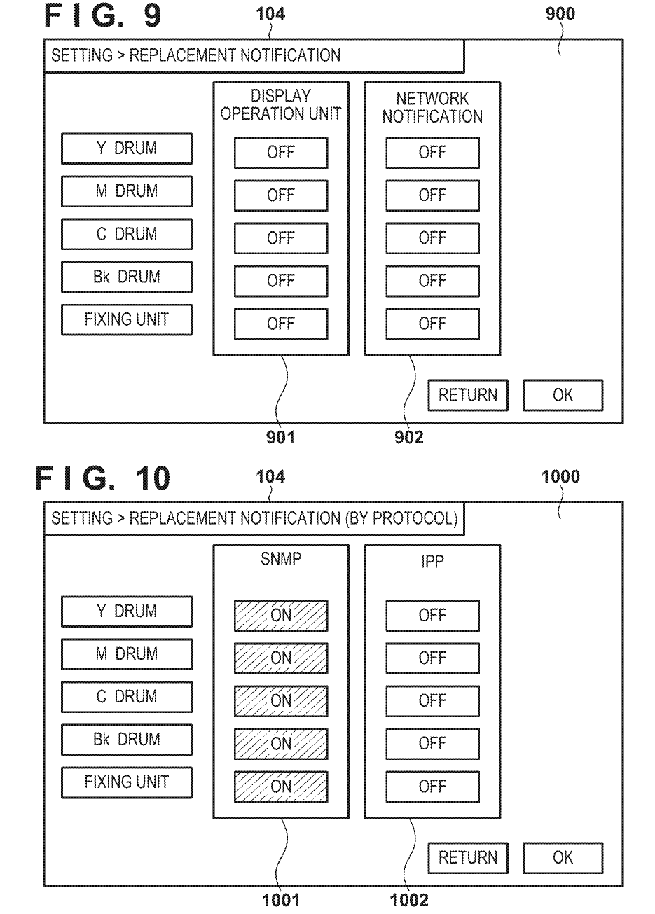

A setting screen 900 to be displayed on the operation unit 104 will be described with reference to FIG. 9. The setting screen 900 is a screen that can switch between network notification setting of the consumable part to the external apparatuses (301 and 302) and notification setting of the consumable part to the operation unit 104 of the image forming apparatus 101. The setting screen 900 includes a SW 901 that switches ON/OFF of the notification of replacement of the consumable part in the operation unit 104, and a SW 902 that switches ON/OFF of the notification of replacement to the external apparatuses (301 and 302) connected to the network. The SW 901 and the SW 902 are displayed in an independently switchable manner. The SW 901 and the SW 902 are provided for each consumable part. Note that the SW 901 is an example of "third object".

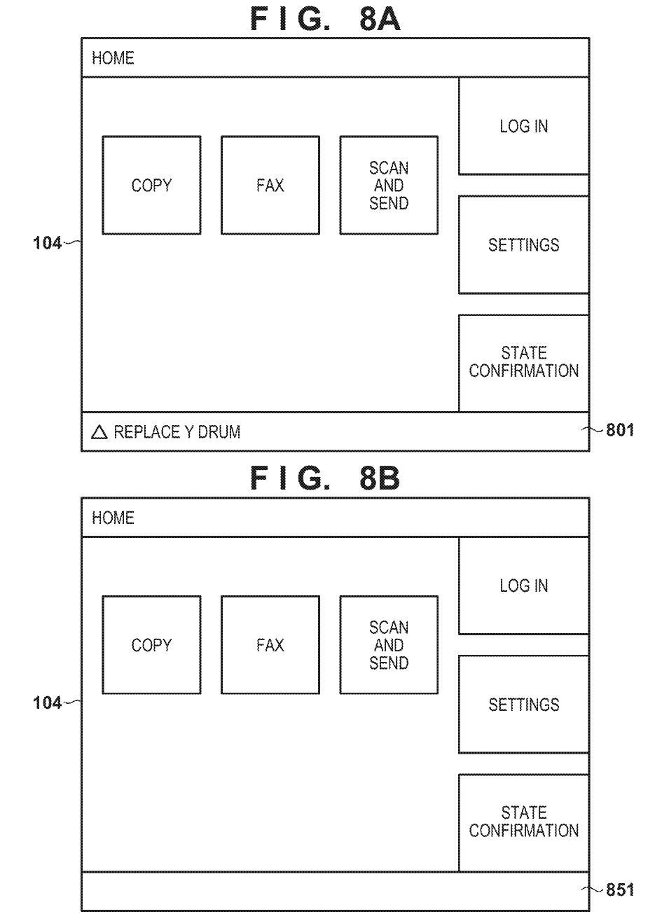

In the example illustrated in FIG. 9, since all the notification settings are OFF, in a case where the drum unit (Y) 206 exceeds the replacement guideline, the replacement notification is not displayed on the operation unit 104 and the display apparatuses of the external apparatuses (301 and 302). That is, the CPU 107 of the image forming apparatus 101 displays the screen illustrated in FIG. 8B, for example, by using the operation unit 104. The screen includes a status line 851 that displays the status of the image forming apparatus 101. However, in a case of the setting example illustrated in FIG. 9, the CPU 107 receives the OFF setting of the SW 901 of the drum unit (Y) 206 corresponding to Y. Therefore, even in a case where the consumption level of the drum unit (Y) 206 exceeds the replacement guideline, the CPU 107 does not display a replacement message in the status line 851. On the other hand, in a case where the SW 901 of the drum unit (Y) 206 corresponding to Y is changed to ON on the setting screen 900 of the operation unit 104, the CPU 107 receives this change operation. Then, in a case where the consumption level of the drum unit (Y) 206 exceeds the replacement guideline, the CPU 107 displays a replacement message 801 on the status line 851 as illustrated in FIG. 8A.

### One Aspect of Actions and Effects

According to the image forming apparatus 101 according to the first modification, the replacement message of the drum unit (Y) 206 is not displayed in the image forming apparatus 101 in addition to the external apparatuses (301 and 302). Therefore, it is less cumbersome to the user who desires to use the drum unit (Y) 206 in excess of the replacement guideline.

### SECOND MODIFICATION

The second modification shows an example in which existence or absence of notification of a replacement message to the external apparatuses (301 and 302) on a network is settable independently for each communication protocol of the network. A setting screen 1000 to be displayed on the operation unit 104 of the image forming apparatus 101 will be described with reference to FIG. 10. The setting screen 1000 includes a SW 1001 that switches ON/OFF of notification in a case where communication is performed by a simple network management protocol (SNMP). The setting screen 1000 includes a SW 1002 that switches ON/OFF of notification in a case where communication is performed by Internet printing protocol (IPP). Note that the setting screen 1000 illustrated in FIG. 10 illustrates an example in which the replacement notification is set to ON in a case where communication is performed using the SNMP, and the replacement notification is set to OFF in a case where communication is performed using the IPP. The CPU 107 may display the setting screen 1000 on which similar switching can be applied regarding protocol methods other than the SNMP and the IPP. The SNMP and the IPP are examples of "communication method".

### One Aspect of Actions and Effects

For example, there is a case of desiring to display the replacement notification of the drum unit (Y) 206 in an external apparatus to be accessed by the SNMP, but not desiring to display the replacement notification of the drum unit (Y) 206 in an external apparatus to be accessed by the IPP. The image forming apparatus 101 according to the second modification is useful in a case of desiring to switch the display of the replacement notification of the drum unit (Y) 206 corresponding to the external apparatus to be communicated using a different communication protocol.

### THIRD MODIFICATION

The third modification shows an example in which the operation unit 104 of the image forming apparatus 101 can set notification of consumption level information (an example of "data") of a consumable part to the external apparatuses (301 and 302) connected to the network. For example, as illustrated in FIG. 7A, the consumption level information is the remaining amounts (730, 731, 732, 733) of the consumption level of the respective drums of Y/M/C/K and the remaining amount 734 of the consumption level of the fixing unit until the replacement guideline. Note that the remaining amount is expressed by a ratio (%) with respect to the replacement guideline. Such setting switching may be linked to selection of the SWs 501 to 505 in the above embodiment, or a new SW may be provided separately from the SWs 501 to 505 and such setting switching may be linked to selection of the newly provided SW.

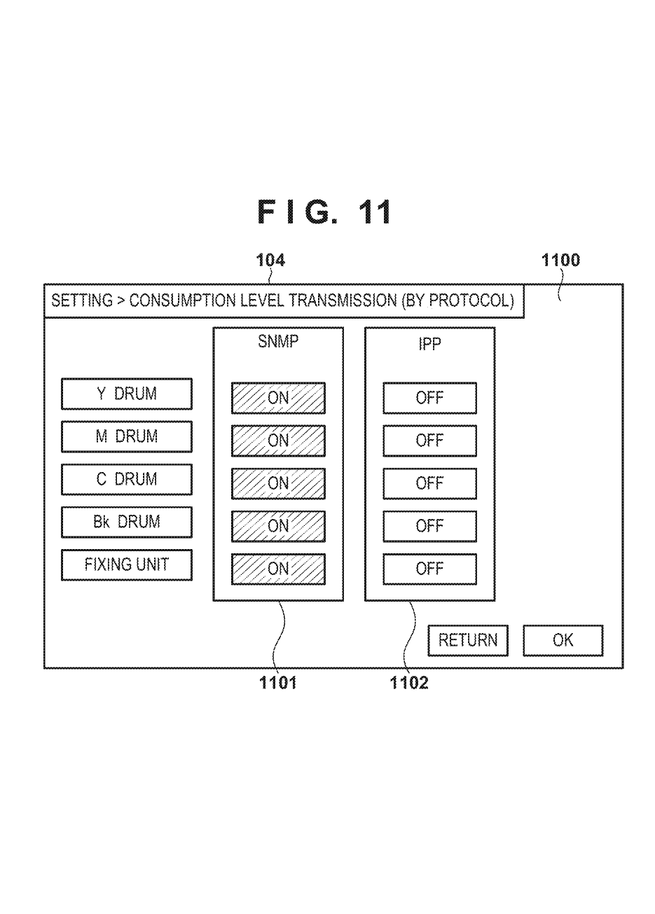

A setting screen 1100 including the SW of the notification setting of the consumption level information on the consumable part will be described with reference to FIG. 11. The setting screen 1100 includes an SW 1101 that switches ON/OFF of notification of the consumption level information in a case where communication is performed by the SNMP. The setting screen 1100 includes a SW 1102 that switches ON/OFF of notification in a case where communication is performed by the IPP. Such SWs 1101 and 1102 are displayed for each consumable part (an example of "second object"). In the example illustrated in FIG. 11, in a case where communication is performed by the SNMP, all notifications of the consumption level information are set to ON. On the other hand, in a case where communication is performed by the IPP, all notifications of the consumption level information are set to OFF.

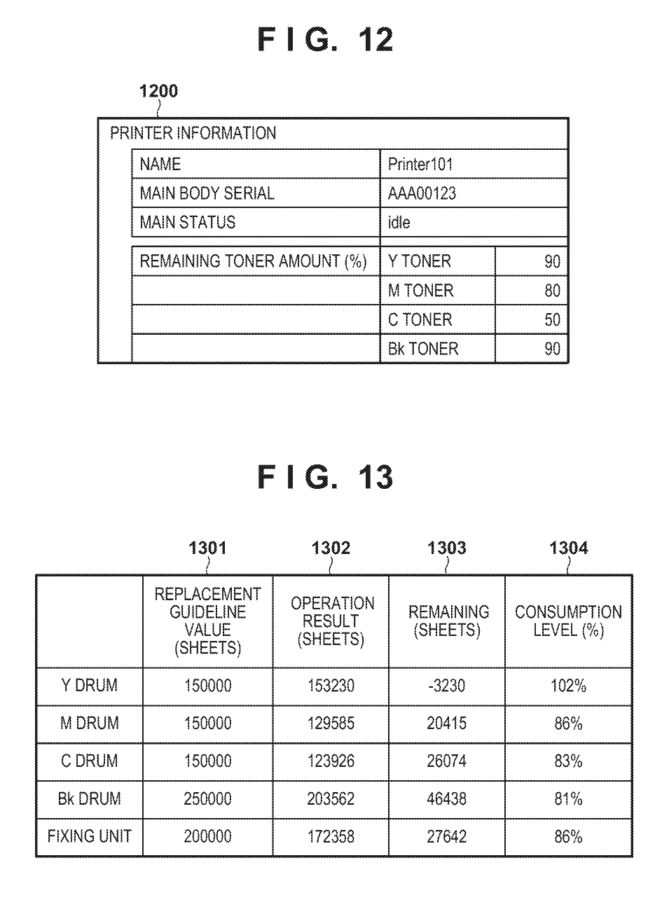

FIG. 12 illustrates printer information 1200 to be notified by the IPP from the image forming apparatus 101 to the external apparatuses (301 and 302) in the case of the notification setting illustrated in FIG. 11. The printer information 1200 includes neither the consumption levels (730, 731, 732, 733, 734) of the consumable part as illustrated in FIG. 7A nor the replacement message 405 corresponding to the replacement notification 740. Therefore, the external apparatus 301 does not receive the printer information 1200 that enables determination of whether or not the consumable part has reached the replacement guideline value.

### One Aspect of Actions and Effects

There is a case where an application or a tool for displaying a replacement message based on information on the consumption level of a consumable part has been installed in the external apparatuses (301 and 302). According to the third modification, in such a case, it is possible to suppress the replacement message of the consumable part from being displayed in the external apparatuses (301 and 302).

### OTHER MODIFICATIONS

The replacement guideline value used in the determination in S654 may be an absolute value of the number of sheets on which an image is formed by the operation of the drum units 206 to 209 or the fixing unit 213. As an alternative to the determination in S654 as to whether or not the consumption level exceeds the replacement guideline value, it may be determined whether or not a use period of the consumable part has exceeded a preset replacement period. Then, the processing of S655 may be executed if the use period of the consumable part exceeds the preset replacement period. The number of replacement guidelines or the replacement period may be estimated from a statistical distribution of past failure results for each consumable part, for example.

The consumable part described above may include a part having been consumed by an operation regarding image formation of the image forming apparatus 101 (an example of "part that is consumed in response to image forming operation"). The setting of existence or absence of a notification according to the above embodiment and modification may be applied to the remaining amount of toner or the remaining number of sheets (an example of "substance that is consumed in response to image forming operation"). Alternatively, it may be applied to consumption or deterioration of parts that affect the quality of image formation. The SW that switches ON/OFF of the replacement notification as illustrated in FIG. 5 need not be displayed. Alternatively, the CPU 107 (an example of "display control unit") may output the setting screen 500 for replacement notification of consumable parts to an external apparatus using the network I/F 112 (a so-called remote UI). Then, the CPU 107 of the image forming apparatus 101 may acquire the notification setting of replacement from the external apparatus via the network. Regarding at least one of the consumable parts, ON/OFF of replacement notification may be set at the time of product shipment.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2025-001911, filed January 6, 2025, which is hereby incorporated by reference herein in its entirety.

What is claimed is:

1. An image forming apparatus comprising:
a first unit;
a second unit;
one or more memories that store a set of instructions; and
one or more processors that execute the set of instructions to:
perform a first setting as to whether or not to transmit a first notification prompting replacement of the first unit to an external apparatus via a network on condition that a consumption level of the first unit has reached a predetermined consumption level;
perform a second setting as to whether or not to transmit a second notification prompting replacement of the second unit to the external apparatus via the network on condition that a consumption level of the second unit has reached a predetermined consumption level; and
control to transmit the first notification to the external apparatus based on the first setting and to transmit the second notification to the external apparatus based on the second setting.

2. The image forming apparatus according to claim 1, wherein
the first notification includes a first message indicating that the first unit is to be replaced, and
the second notification includes a second message indicating that the second unit is to be replaced.

3. The image forming apparatus according to claim 1, further comprising
a display,
wherein
the one or more processors further execute instructions in the one or more memory devices to:
perform a third setting as to whether or not to perform the first notification by the display.

4. The image forming apparatus according to claim 3, wherein
the one or more processors further execute instructions in the one or more memory devices to:
perform a fourth setting as to whether or not to perform the second notification by the display.

5. The image forming apparatus according to claim 1, wherein
whether or not to transmit the first notification is displayed for each communication method between the image forming apparatus and the external apparatus.

6. The image forming apparatus according to claim 1, wherein
the first notification further includes data enabling determination of whether or not to replace the first unit.

7. The image forming apparatus according to claim 6, wherein
the second notification further includes data enabling determination of whether or not to replace the second unit.

8. The image forming apparatus according to claim 1, wherein
the first unit is a unit that is consumed in response to image formation.

9. The image forming apparatus according to claim 8, wherein
the first unit includes a toner, a sheet on which an image is formed, an electro-photosensitive drum for transferring a toner to a sheet, or a fixing unit that fixes the toner transferred to the sheet.

10. A control method for an image forming apparatus, the control method comprising:
performing a first setting as to whether or not to transmit a first notification prompting replacement of a first unit of the image forming apparatus to an external apparatus via a network on condition that a consumption level of the first unit has reached a predetermined consumption level;
performing a second setting as to whether or not to transmit a second notification prompting replacement of a second unit of the image forming apparatus to the external apparatus via the network on condition that a consumption level of the second unit has reached a predetermined consumption level; and
controlling to transmit the first notification to the external apparatus based on the first setting and to transmit the second notification to the external apparatus based on the second setting.

11. A non-transitory computer-readable storage medium storing a computer program for causing a computer to execute each process in a control method for an image forming apparatus, the control method including
performing a first setting as to whether or not to transmit a first notification prompting replacement of a first unit of the image forming apparatus to an external apparatus via a network on condition that a consumption level of the first unit has reached a predetermined consumption level;
performing a second setting as to whether or not to transmit a second notification prompting replacement of a second unit of the image forming apparatus to the external apparatus via the network on condition that a consumption level of the second unit has reached a predetermined consumption level; and
controlling to transmit the first notification to the external apparatus based on the first setting and to transmit the second notification to the external apparatus based on the second setting.
